(19) United States
(12) Patent Application Publication
(10) Pub. No.: US 2015/0376038 A1
(43) Pub. Date: Dec. 31, 2015

(54) CLARIFICATION OF HYDROCARBONS AND SUSPENDED MATTER FROM AN AQUEOUS MEDIUM

(71) Applicant: HaloSource, Inc., Bothell, WA (US)

(72) Inventors: Ryan Wietholter, Chicago, IL (US); Francis Kneib, Phoenix, AZ (US); Everett J. Nichols, Edmonds, WA (US)

(73) Assignee: HaloSource, Inc., Bothell, WA (US)

(21) Appl. No.: 14/790,443

(22) Filed: Jul. 2, 2015

Related U.S. Application Data
(63) Continuation of application No. 13/316,207, filed on Dec. 9, 2011.
(60) Provisional application No. 61/433,686, filed on Jan. 18, 2011.
(60) Provisional application No. 61/422,545, filed on Dec. 13, 2010.

(51) Int. Cl. C02F 1/52; C02F 1/54

(52) U.S. Cl. CPC C02F 1/5236; C02F 1/54; C02F 1/5263; C02F 2103/365

(57) ABSTRACT

A method for removing components from an aqueous medium is described. The method includes dispensing a formulation comprising one or more of zinc chloride, calcium chloride, zirconium acetate and zirconium oxychloride to an aqueous medium. The method includes allowing the formation of floccules in the aqueous medium, wherein the floccules contain the component to be removed. The method includes separating the floccules from the aqueous medium to remove the component.

### CROSS-REFERENCES TO RELATED APPLICATIONS

This application is a continuation of U.S. patent application Ser. No. 13/316,207, filed Dec. 9, 2011, which claims the benefit of U.S. Provisional Application Nos. 61/433,686, filed Jan. 18, 2011, and 61/422,545, filed Dec. 13, 2010, all of which applications are incorporated herein expressly by reference.

### BACKGROUND

Exploration and recovery of natural resources, such as oil, gas, and minerals can consume or result in vast quantizes of contaminated water. Water used in this type of service can have different names depending on the specific use in which the water is used. Water can be called drill water, produced water, flow back water, or frac flow back water to name just a few. After service, the water can have many contaminants that can come from natural sources, or contaminants can be introduced intentionally so as to provide the water with some desired characteristic. Contaminants can be varied and wide ranging, and can include naturally—occurring contaminants and artificially introduced contaminants. A problem exists on how to clarify the water of contaminants once it has been used or recovered so that it can be released into the environment without causing harm.

Disclosed herein are methods and formulations to clarify such water.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a method for removing components from an aqueous medium is disclosed. The method includes dispensing a formulation comprising one or more of zinc chloride, calcium chloride, zirconium acetate, zirconium oxychloride, or any combination thereof to an aqueous medium, allowing the formation of floccules in the aqueous medium, wherein the floccules contain a component to be removed, and separating the floccules with the component from the aqueous medium.

In one embodiment of the method, the aqueous medium is drill water and the formulation comprises zinc chloride.

In one embodiment of the method, the aqueous medium is drill water and the formulation comprises zinc chloride and calcium chloride.

In one embodiment of the method, the aqueous medium is drill water and the formulation comprises calcium chloride and zirconium acetate, wherein the amount of calcium chloride by weight is equal to or less than the zirconium acetate.

In one embodiment of the method, the aqueous medium is drill water and the formulation comprises calcium chloride.

In one embodiment of the method, the aqueous medium is drill water and the formulation comprises calcium chloride and zinc chloride.

In one embodiment of the method, the method further includes dispensing zinc chloride or calcium chloride or both into the aqueous medium, allowing the floccules to form a first time, filtering the floccules from the aqueous medium to result in a filtrate, and dispensing zirconium oxychloride or zirconium acetate or both into the filtrate, and allowing floccules to form a second time in the filtrate.

In one embodiment of the method, the method further includes dispensing zinc chloride or calcium chloride or both into the aqueous medium, allowing the floccules to form a first time in the aqueous medium, separating the floccules from the aqueous medium to result in a supernatant liquid, and dispensing zirconium oxychloride or zirconium acetate or both into the supernatant liquid, and allowing floccules to form a second time in the supernatant liquid.

In one embodiment of the method, the aqueous medium is drill water, produced water, frac water, or flow back water.

In one embodiment of the method, the aqueous medium is bilge water.

In one embodiment of the method, the aqueous medium is wastewater from a sewage treatment plant.

In one embodiment of the method, the aqueous medium is industrial wastewater.

In one embodiment of the method, the aqueous medium is food processing wastewater.

In one embodiment of the method, the aqueous medium is potable water.

In one embodiment of the method, the aqueous medium is recreational water.

In one embodiment of the method, the aqueous medium comprises mine tailings.

In one embodiment of the method, the formulation further comprises water.

In one embodiment of the method, the formulation is a solid.

In one embodiment of the method, the formulation is an aqueous solution.

In one embodiment of the method, the formulation is an aqueous slurry.

In one embodiment of the method, the formulation further comprises a natural polymer or a derivative of a natural polymer.

In one embodiment of the method, the formulation further comprises one or more of a polysaccharide, guar gum, xanthan gum, alginate, carboxymethylcellulose, chitosan, a cationic guar, a starch, a cationic starch, an anionic starch, carrageenans, pectin, arabic gum, karaya gum, tragacanth gum, glucomannan, or any combination thereof.

In one embodiment of the method, the formulation further comprises magnesium chloride.

In one embodiment of the method, the formulation comprises zinc chloride, calcium chloride, ferric chloride, and chitosan.

In one embodiment of the method, the formulation comprises calcium chloride, magnesium chloride, and glucomannan.

In one embodiment of the method the formulation comprises zirconium acetate and chitosan.

In one embodiment of the method, the formulation comprises zirconium acetate and a polysaccharide.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a method in accordance with one embodiment of the invention;

FIG. 2 is a photograph of aqueous media treated in accordance with one embodiment of the invention;

FIG. 3 is a photograph of aqueous media treated in accordance with one embodiment of the invention;

FIG. 4 is a photograph of aqueous media treated in accordance with one embodiment of the invention;

FIG. 5 is a photograph of aqueous media treated in accordance with one embodiment of the invention;

FIG. 6 is a photograph of aqueous media treated in accordance with one embodiment of the invention;

FIG. 7A is a photograph of aqueous media treated in accordance with one embodiment of the invention;

FIG. 7B is a photograph of aqueous media treated in accordance with one embodiment of the invention;

FIG. 8 is a photograph of aqueous media treated in accordance with one embodiment of the invention;

FIG. 9 is a photograph of aqueous media treated in accordance with one embodiment of the invention; and

FIG. 10 is a photograph of aqueous media treated in accordance with one embodiment of the invention.

### DETAILED DESCRIPTION

In one embodiment, a method and formulation for treating and clarifying any aqueous medium (plural:media) containing hydrocarbons and suspended sediments derived from oil/gas wells is described. The aqueous media can be comprised of produced water, drill water, flow back water, or water derived from hydraulic fracturing operations in the harvest of natural gas or oil from shale. The produced water, drill water, flow back water, or water derived from oil drilling operations results from the harvest of oil from onshore or offshore operations. Drill water as used herein includes any water used in drilling operations, such as water used for drilling mud. Produced water as used herein refers to any water that is produced along with and accompanies the recovery of a natural resource, such as oil. Flow back water as used herein includes the water that returns from the well during fracking (fracturing) operations to recover gas or oil.

The aqueous media may contain one or more of the following constituents or contaminants that can be removed with the methods and formulations described herein. The methods and formulations may be used to remove drill cuttings comprised of oil; semi-volatile organic compounds; total organic hydrocarbons; aromatic hydrocarbons; naphthalenes, including naphthenic acids, 2-methylnaphthalene and 1-methylnaphthalene; acenaphthylene; fluorene; fluoranthene; pyrene; benzo [b] fluoranthene; benzo[g,h,I,]perylene; #2 diesel (>C12-C24); motor oil, gasoline; phenanthrene; anthracene; benzene; toluene; xylene; ethylbenzene; radium 226; radium 228; 2-Butone; 2,4-Dimethylphenol; benzo(a)pyrene; chlorobenzene; Di-n-butylphthalate; n-Alkanes; p-Chloro-m-cresol; phenol; steranes; triterpanes; sulfated organic hydrocarbons; hydrogen sulfide; fine sediments of shale and rock; sand; clay fines including montmorillonites such as bentonite; dissolved salts; oxyanions such as carbonates; sulfates; phosphates and nitrates; and drilling fluid additives from wellbores of oil/gas drilling operations including biocides, glutaraldehyde, formaldehyde, ethoxylated alcohols, benzene, kerosene, toluene, xylene, Dazomet, ethylene glycol, polyethylene glycol, boric acid, borate salts, guar gum, xanthan gum, proppants, silica, quartz sand, synthetic ceramics, tannins, humic acid, propargyl alcohol, citric acid, methanol, isopropanol, boric oxide, petroleum distillate blend, polysaccharides, potassium carbonate, hydrotreated light distillate, ethoxylated alcohol, diesel, 2,2-Dibromo-3-Nitrilopropionamide, acetic anhydride, monoethanolamine, gel polymer chain breakers such as ammonium persulfate, corrosion inhibitors such as N,N-dimethyl formamide, polyacrylamides, polyaluminum chloride, alum, hydroxyethylcellulose, hydroxpropylcellulose, chitosan, chitin.

Treatment of aqueous media with the formulation(s) results in flocculation and settling of one or more of the components contained in the aqueous media such that the flocculated components can be separated from the aqueous phase by gravity settling, centrifugation, filtration or a combination thereof. Treatment of aqueous media with the formulations disclosed herein may occur in ponds, tanks, pools, tubs, vessels, and the like.

In other embodiments, the method and formulation(s) can also be used to treat and clarify aqueous media comprising bilge water that can contain various components such as oil, diesel, gasoline, bacteria, viruses, fecal coliforms, sulfur-containing compounds, anaerobic bacteria, dissolved metal ions and oxyanions. Treatment of the aqueous media with the formulation(s) results in flocculation and settling of one or more of the components contained in the aqueous media such that the flocculated components can be separated from the aqueous phase by employing a method involving gravity settling, centrifugation, filtration or a combination thereof. For example, a tank, pond, or vessel can be pumped such that the flocculated components remain trapped in a filter, and the filtrate is returned to the environment or further collected in another tank, pond, or vessel. Alternatively, only the supernatant liquid above the sediment is pumped from the tank, pond, or vessel, leaving behind the sediment, which can then be removed through the use of scrapers, or if large enough, with backhoes.

In other embodiments, the method and formulation(s) can also be used to treat and clarify an industrial or pharmaceutical aqueous media containing hydrocarbons, suspended pigments, suspended insoluble organic matter, tannins, humic acid, suspended metal oxides, suspended metal oxyhalides, titanium dioxide, suspended clay fines, suntan and sunscreen ingredients, fat, oils, grease, microorganisms including algae, cyanobacteria, microcystins, bacteria, viruses, protozoa and protozoal cysts such as cryptosporidium oocysts, organic polymers and/or synthetic organic compounds such as Kevlar and others such as proteins, polynucleotides, genes, and/or immune complexes of commercial value. Treatment of the aqueous media with the formulation(s) results in flocculation and settling of one or more of the components contained in the aqueous media such that the flocculated components can be separated from the aqueous phase by gravity settling, centrifugation, filtration, or a combination thereof.

In other embodiments, the method and formulation(s) can also be used to treat and clarify an aqueous media derived from wastewater such as a sewage treatment plant or an industrial wastewater stream containing hydrocarbons, suspended pigments, suspended insoluble organic matter, tannins, humic acid, suspended metal oxides, suspended metal oxyhalides, titanium dioxide, suspended clay fines, suntan and sunscreen ingredients, fat, oils, grease, microorganisms including algae, cyanobacteria, microcystins, bacteria, viruses, proteins, carbohydrates, lipids, protozoa and protozoal cysts such as cryptosporidium oocysts, organic polymers and/or synthetic organic compounds such as Kevlar and others of commercial value. The wastewater may contain organic polymers, synthetic polymers, microconstituents such as musk oils, triclosan, industrial chemical wastes, endocrine disruptors, drugs, ibuprofen, Prozac, etc. Treatment of the aqueous media with the formulation(s) results in flocculation and settling of one or more of the components contained in the aqueous media such that the flocculated components can be separated from the aqueous phase by gravity settling, centrifugation or filtration or a combination thereof.

In other embodiments, the method and formulation(s) can also be used to treat and clarify an aqueous media used for the production of potable drinking water. Such media may contain hydrocarbons, suspended pigments, suspended insoluble organic matter, tannins, humic acid, suspended metal oxides, suspended metal oxyhalides, titanium dioxide, suspended clay fines, suntan and sunscreen ingredients, fat, oils, grease, microorganisms including algae, cyanobacteria, microcystins, bacteria, viruses, proteins, carbohydrates, lipids, protozoa and protozoal cysts such as cryptosporidium oocysts, organic polymers, synthetic polymers, microconstituents including musk oils, triclosan, endocrine disruptors, drugs, ibuprofen, Prozac, etc. Treatment of the aqueous media with the formulation(s) results in flocculation and settling of one or more of the components contained in the aqueous media such that the flocculated components can be separated from the aqueous phase by gravity settling, centrifugation or filtration or a combination thereof.

In other embodiments, the method and formulation(s) can also be used to treat and clarify recreational water. Recreational water includes, but is not limited to, pool water, spa water, hot tub water, waterpark water, and the like. Such water may contain hydrocarbons, suspended pigments, suspended insoluble organic matter, tannins, humic acid, suspended metal oxides, suspended metal oxyhalides, titanium dioxide, suspended clay fines, suntan and sunscreen ingredients, cyanuric acid, fat, oils, grease, microorganisms including algae, cyanobacteria, microcystins, bacteria, viruses, proteins, carbohydrates, lipids, protozoa and protozoal cysts such as cryptosporidium oocysts, organic polymers, synthetic polymers, microconstituents including musk oils, triclosan, endocrine disruptors, drugs, ibuprofen, Prozac, etc. Treatment of the aqueous media with the formulation(s) results in flocculation and settling of one or more of the components contained in the aqueous media such that the flocculated components can be separated from the aqueous phase by gravity settling, centrifugation, filtration, or a combination thereof.

In other embodiments, the method and formulation(s) can also be used to treat and clarify an aqueous media comprising mine tailings. Such aqueous media may contain hydrocarbons, naphthenic acids, suspended pigments, suspended insoluble organic matter, tannins, humic acid, suspended metal oxides, suspended metal oxyhalides, toxic metals such as arsenic, lead, chromium, cadmium, or mercury, titanium dioxide, suspended clay fines, suntan and sunscreen ingredients, cyanuric acid, fat, oils, grease, microorganisms including algae, cyanobacteria, microcystins, bacteria, viruses, proteins, carbohydrates, lipids, protozoa and protozoal cysts such as cryptosporidium oocysts, organic polymers, synthetic polymers, microconstituents including musk oils, triclosan, endocrine disruptors, drugs, ibuprofen, Prozac, etc. Treatment of the aqueous media with the formulation(s) results in flocculation and settling of one or more of the components contained in the aqueous media such that the flocculated components can be separated from the aqueous phase by gravity settling, centrifugation, filtration, or a combination thereof.

In other embodiments, the method and formulation(s) can also be used to treat and clarify an aqueous media in need of remediation. Such aqueous media may contain hydrocarbons, suspended pigments, naphthenic acids, PCB's, benzene, xylene, toluene, ethylbenzene, suspended insoluble organic matter, tannins, humic acid, suspended metal oxides, suspended metal oxyhalides, toxic metals such as arsenic, lead, chromium, cadmium, or mercury, titanium dioxide, suspended clay fines, suntan and sunscreen ingredients, cyanuric acid, fat, oils, grease, microorganisms including algae, cyanobacteria, microcystins, bacteria, viruses, proteins, carbohydrates, lipids, protozoa and protozoal cysts such as cryptosporidium oocysts, organic polymers, synthetic polymers, microconstituents including musk oils, triclosan, endocrine disruptors, drugs, ibuprofen, Prozac, etc. Treatment of the aqueous media with the formulation(s) results in flocculation and settling of one or more of the components contained in the aqueous media such that the flocculated components can be separated from the aqueous phase by gravity settling, centrifugation, filtration, or a combination thereof.

Formulations to treat any one of the aqueous media described herein include one or more of the compounds zinc chloride, calcium chloride, zirconium acetate, zirconium oxychloride, or any combination thereof. Formulations to treat the various aqueous media described above can be provided as solids, liquids or slurries. In some embodiments, the liquid formulations are aqueous solutions of one or more compounds. In some embodiments, the formulation is a slurry. A slurry can be made from a single compound or more than one compound. A slurry can include water and an excess of one or more compounds, such that the compound(s) exceeds its solubility limit in water. For example, an aqueous slurry can be a mixture of water and one or more compounds, wherein at least one compound is insoluble. A slurry can include, for example, water, an excess amount of calcium chloride that will not dissolve fully in the water, and zinc chloride. In some embodiments, the formulations may comprise aqueous solutions of metal halides or alkaline earth metal halides. The metal halides and alkaline earth metal halides can be anhydrous or provided as hydrates. The solvent for the metal halides and alkaline earth metal halides can be water. Metals for the metal halides may include zinc, zirconium, iron, aluminum, potassium, magnesium, and calcium. Alkaline earth metals include calcium and magnesium. Halogens may include chlorine. In some embodiments, the formulations may comprise a transition metal acetate, a transition metal carbonate, or a transition metal sulfate. The transition metal can be zirconium. In some embodiments, the formulations may comprise transition-metal oxyhalides. The transition metal can be zirconium and the oxyhalide is oxychloride.

One embodiment of the formulation is comprised of an aqueous solution of zinc chloride (ZnCl₂). The concentration of zinc chloride can range from 0.01 wt. % to 82 wt. %. A concentration of zinc chloride in a formulation can be any weight percent between these limits, including approximately 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, or any fraction thereof. A preferred concentration is about 26 wt. % in water.

Another embodiment of the formulation is comprised of an aqueous solution of calcium chloride (CaCl₂). The concentration of calcium chloride can range from 0.01 wt. % to 43 wt. %. A concentration of calcium chloride can be any weight percent between these limits, including approximately 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, or any fraction thereof. A preferred concentration is about 21 wt. % in water.

Another embodiment of the formulation is comprised of an aqueous solution of both zinc chloride and calcium chloride. The concentration of ZnCl₂ can range from 0.01 wt. % to 82 wt. % and any value in between, and the concentration of CaCl₂ can range from 0.01 wt. % to 43 wt. % and any value in between, as long as, taken together, the weight percent of ZnCl₂ and CaCl₂ does not exceed approximately 82%. A preferred concentration is about 26 wt. % in water of ZnCl₂ and about 21 wt. % in water of CaCl₂.

Another embodiment of the formulation is comprised of an aqueous solution of zirconium oxychloride (ZrOCl₂). The solution concentration of zirconium oxychloride can range from 0.01 wt. % to 70 wt. %. A concentration of zirconium oxychloride can be any weight percent between these limits, including approximately 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, or any fraction thereof.

Another embodiment of the formulation is comprised of an aqueous solution of zirconium acetate (Zr(CH₂COO)₂) or (ZrAc). The solution concentration of zirconium acetate can range from 0.01 wt. % to 33 wt. % in one embodiment, 0.01 wt. % to 40 wt. % in one embodiment, or 0.01 wt. % to 50 wt. % in one embodiment, A concentration of zirconium acetate can be any weight percent between these limits, including approximately 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or any fraction thereof.

In other embodiments, the formulations can also be comprised of a combination of zinc chloride and zirconium oxychloride and/or zirconium acetate. The total weight percent for all components can range from 0.01 wt. % to 50 wt. % in water.

In other embodiments, the formulations can also be comprised of a combination of calcium chloride and zirconium oxychloride and/or zirconium acetate. The total weight percent for all components can range from 0.01 wt. % to 50 wt. % in water.

In other embodiments, the formulations can also be comprised of a combination of zinc chloride, calcium chloride and zirconium oxychloride and/or zirconium acetate. The total weight percent for all components can range from 0.01 wt. % to 70 wt. % in water.

In other embodiments, the formulations described herein may further include the addition of one or more natural polymers or chemical derivatives of natural polymers including, but not limited to, polysaccharides, such as guar gum, xanthan gum, alginates, carboxymethylcellulose, chitosan, cationic guar, starches, cationic starches, anionic starches, carrageenans, pectins, arabic gums, karaya gums, tragacanth gums, glucomannans and the like. Natural polymers may be beneficial in enhancing the flocculation and settling, and subsequent removal of hydrocarbons and other components (described above in the various embodiments) from the aqueous medias.

In other embodiments, the formulations described herein, with or without natural polymers or their derivatives, may further include ferric or ferrous salt coagulants, such as ferric chloride, ferric citrate, ferric sulfate, ferrous sulfate, ferric ammonium citrate, ferrous ammonium sulfate, or any combination thereof. In some embodiments ferric chloride can be used with or without any of the other components. For example, one embodiment of a formulation is zinc chloride, calcium chloride, ferric chloride, and chitosan.

In some embodiments, the formulations may consist only of the active components, while in other embodiments, the formulations may consist essentially of the active components, and further include other components that do not change the basic characteristics of the active components.

In some embodiments, one or more of the components are combined to provide a synergistic effect. A synergistic effect is one in which two or more components have an increased activity when compared to the individual effects of the components taken alone.

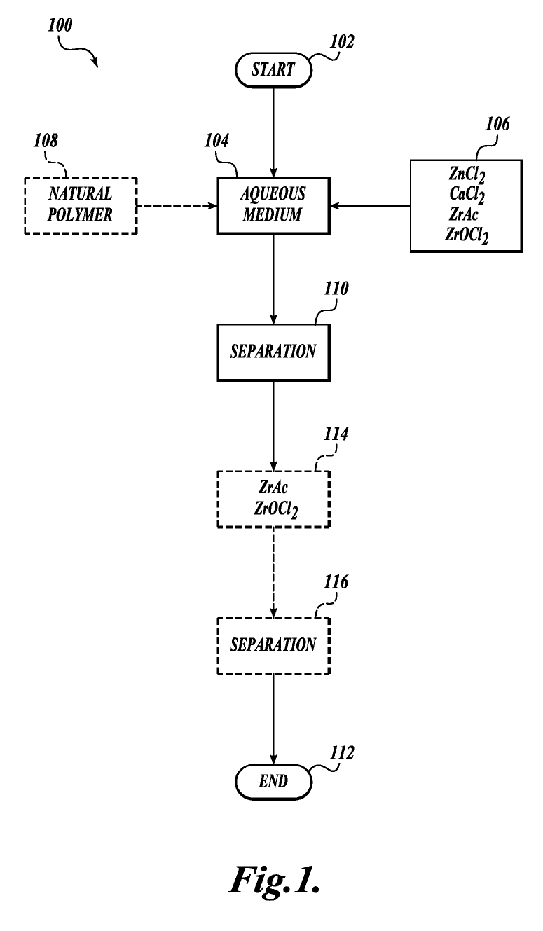

Referring to FIG. 1, a method 100 in accordance with one embodiment is illustrated. The method includes providing an aqueous medium in block 104. The method includes dispensing a formulation of block 106 comprising one or more of zinc chloride, calcium chloride, zirconium acetate, and zirconium oxychloride to the aqueous medium of block 104. The aqueous medium may include any one or more of the aqueous media described herein. The aqueous medium may also include any one or more of the components described herein to be removed. The method includes allowing the zinc chloride and/or calcium chloride and/or zirconium acetate and/or zirconium oxychloride to react with the hydrocarbons or other components to be removed, for a sufficient period of time, to allow the formation of floccules. A sufficient period can be determined experimentally or by visual inspection. Floccules are formed from the component desired to be removed based on interactions it has with a metal or alkaline earth metal. The method includes separating the floccules from the aqueous media. The separation method can include, but is not limited to, separation by filtration, centrifugation, gravity settling, or any combination of two, three, or more processes. For example, a tank, pond, or vessel can be pumped such that the flocculated components remain trapped in a filter, and the filtrate is returned to the environment or further collected in another tank, pond, or vessel. Alternatively, only the supernatant liquid above the sediment is pumped from the tank, pond, or vessel, leaving behind the sediment, which can then be removed through the use of scrapers, or if large enough, with backhoes.

In one embodiment, a first treatment of the aqueous medium with calcium chloride or zinc chloride or both, allowing sufficient time for floccule formation and sedimentation, and separation of the floccules results in the collection of a filtrate or supernatant liquid. The collected filtrate or supernatant liquid can then optionally be treated a second time with zirconium acetate or zirconium oxychloride or both in block 114. The method includes allowing sufficient time for floccule formation and sedimentation. The floccules that then form due to the second treatment can then also be separated from the filtrate or supernatant liquid in block 116.

In one embodiment, the aqueous medium may be mixed after adding the formulation. Mixing the treated aqueous media improves and hastens the flocculation and separation, but mixing is not necessary. In some embodiments, the components of the formulation may be added separately and sequentially or added together. In one embodiment, the method may include adding the zinc chloride and/or calcium chloride and/or zirconium acetate and/or zirconium oxychloride as a solid to the aqueous media to be treated, followed by mixing. Also in this case, mixing is desired but may not be necessary. The concentration of zinc chloride and/or calcium chloride and/or zirconium acetate and/or zirconium oxychloride or any combination thereof used to effectively flocculate and settle the hydrocarbons or other components in the various media and achieve desired water clarity is in the range of 1 ppm to 100,000 ppm. The concentration can include any values between these limits. An optimal concentration that is economically viable is desired. For aqueous media derived from oil and gas drilling waters, a range for calcium chloride, zinc chloride, zirconium oxychloride, zirconium acetate, or any combination thereof can be from 50 ppm to 10,000 ppm.

In oil and shale gas operations, water is used in very high quantities and the recycling of drill water, frac water, flow back water and produced water is highly desired and reduces the burden of competing with other water demands from other sectors. It is demonstrated that the treatment methods described herein can effectively recover more water from oil and gas drilling and mining operations and, thus, capture additional value.

In some embodiments, the treated aqueous media can be further treated by microfiltration, ultrafiltration, nanofiltration, forward osmosis and/or reverse osmosis using commercially available membranes.

The suspended matter such as the hydrocarbons and/or other components to be removed in the aqueous media can be in the micron size range, submicron size range, or nano-micron size range or a combination that encompasses all size ranges.

A method for removing components from an aqueous medium is described. The method includes dispensing a formulation comprising one or more of zinc chloride, calcium chloride, zirconium acetate, zirconium oxychloride, or any combination thereof to an aqueous medium. The method includes allowing the formation of floccules in the aqueous medium, wherein the floccules contain a component to be removed. The method includes separating the floccules with the component from the aqueous medium.

In one embodiment of the method, the aqueous medium is drill water and the formulation comprises zinc chloride.

In one embodiment of the method, the aqueous medium is drill water and the formulation comprises zinc chloride and calcium chloride.

In one embodiment of the method, the aqueous medium is drill water and the formulation comprises calcium chloride and zirconium acetate, wherein the amount of calcium chloride by weight is equal to or less than zirconium acetate.

In one embodiment of the method, the aqueous medium is drill water and the formulation comprises calcium chloride.

In one embodiment of the method, the aqueous medium is drill water and the formulation comprises calcium chloride and zinc chloride.

In one embodiment of the method, the method further includes dispensing zinc chloride or calcium chloride or both into the aqueous medium, allowing the floccules to form a first time, filtering the floccules from the aqueous medium to result in a filtrate, and dispensing zirconium oxychloride or zirconium acetate or both into the filtrate, and allowing floccules to form a second time in the filtrate.

In one embodiment of the method, the method further includes dispensing zinc chloride or calcium chloride or both into the aqueous medium, allowing the floccules to form a first time in the aqueous medium, separating the floccules from the aqueous medium to result in a supernatant liquid, and dispensing zirconium oxychloride or zirconium acetate or both into the supernatant liquid, and allowing floccules to form a second time in the supernatant liquid.

In one embodiment of the method, the aqueous medium is drill water, produced water, frac water, or flow back water.

In one embodiment of the method, the aqueous medium is bilge water.

In one embodiment of the method, the aqueous medium is wastewater from a sewage treatment plant.

In one embodiment of the method, the aqueous medium is industrial wastewater.

In one embodiment of the method, the aqueous medium is food processing wastewater.

In one embodiment of the method, the aqueous medium is potable water.

In one embodiment of the method, the aqueous medium is recreational water.

In one embodiment of the method, the aqueous medium comprises mine tailings.

In one embodiment of the method, the formulation further comprises water.

In one embodiment of the method, the formulation is a solid.

In one embodiment of the method, the formulation is an aqueous solution.

In one embodiment of the method, the formulation is an aqueous slurry.

In one embodiment of the method, the formulation further comprises a natural polymer or a derivative of a natural polymer.

In one embodiment of the method, the formulation further comprises one or more of a polysaccharide, guar gum, xanthan gum, alginate, carboxymethylcellulose, chitosan, a cationic guar, a starch, a cationic starch, an anionic starch, carrageenan, pectin, arabic gum, karaya gum, tragacanth gum, glucomannan, or any combination thereof.

In one embodiment of the method, the formulation further comprises magnesium chloride.

In one embodiment of the method, the formulation comprises zinc chloride, calcium chloride, ferric chloride, and chitosan.

In one embodiment of the method, the formulation comprises calcium chloride, magnesium chloride, and glucomannan.

In one embodiment of the method the formulation comprises zirconium acetate and chitosan.

In one embodiment of the method, the formulation comprises zirconium acetate and a polysaccharide.

### Example 1

### Treatment of Drill Water with Calcium Chloride, Zinc Chloride, Alone and in Combination

Two different drill water samples obtained from natural gas shale formations were each treated with three different formulations of zinc chloride alone (25 g/50 g of DI water), calcium chloride alone (25 g/50 g of DI water), and a combination of zinc chloride and calcium chloride. For the combination, zinc chloride (25 g/50 g of DI water) was blended with calcium chloride (25 g/50 g DI water) at a ratio of 9:1. 30 μl of the combination was dosed into 20 ml of drill water samples. 30 μl of zinc chloride or 30 μl calcium chloride were dosed into individual drill water samples as controls. The three formulations were allowed to react with the components in the drill water, and allowed a period of time for floccules to settle.

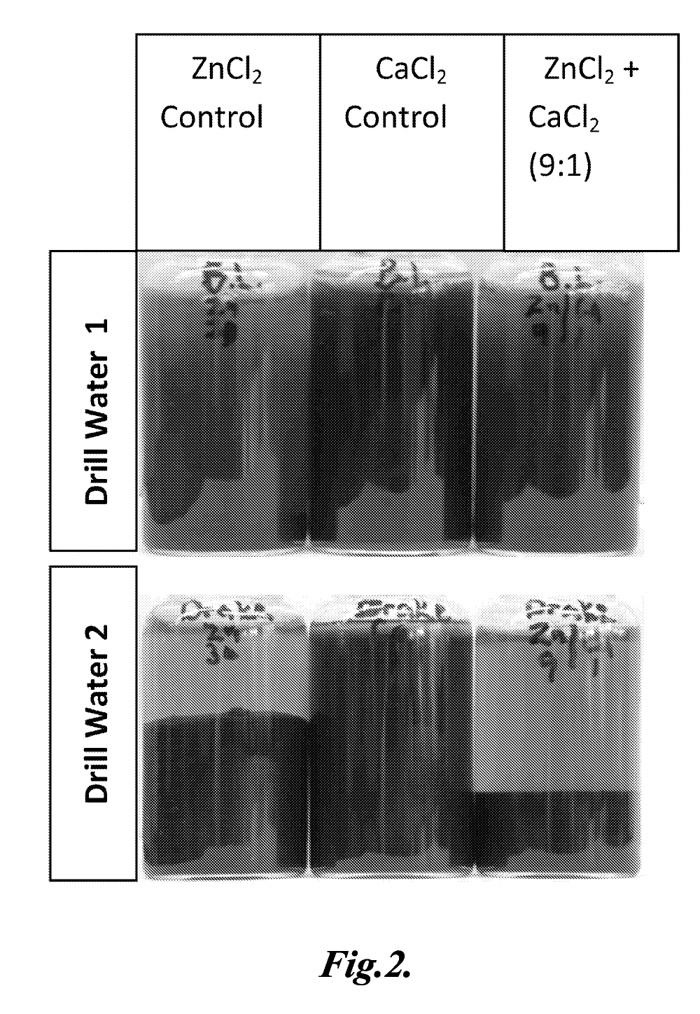

The results are seen in FIG. 2.

As seen in FIG. 2, for the drill water sample 1, calcium chloride was not as effective as zinc chloride in the formation of floccules and resulting settling of the suspended components. The combination of calcium chloride and zinc chloride was similar to zinc chloride alone in its effectiveness.

As seen in FIG. 2, for the drill water sample 2, the combination of calcium chloride and zinc chloride resulted in much better settling of the suspended components compared to the zinc chloride alone and calcium chloride alone. Zinc chloride alone was more effective in flocculation, settling and clarification of the drill water compared to calcium chloride alone. However, the combination of calcium chloride and zinc chloride resulted in a greater volume of clarified water than either calcium chloride and zinc chloride alone.

This example demonstrates that zinc chloride is effective at inducing flocculation and settling and clarification of drill water. This example also demonstrates that a combination of calcium chloride and zinc chloride is more effective at reducing the suspended solids present in the drill water and results in a higher recovery of clarified water that can be subsequently used in other applications, such as hydraulic fracturing.

### Example 2

### Treatment of Drill Water with Calcium Chloride, Zirconium Acetate, Alone and in Combination

Two different drill water samples obtained from natural gas shale formations were treated with formulations of calcium chloride alone (25 g/50 g of DI water), an aqueous solution of zirconium acetate alone (15% to 16% wt. as zirconium). or combinations of calcium chloride and zirconium acetate in different ratios. The combinations were blends of calcium chloride (25 g/50 g of DI water) and an aqueous solution of zirconium acetate (15% to 16% wt. as zirconium). The calcium and zirconium solutions were blended at ratios of 1:9, 5:5, and 9:1, and the blended solutions were used to treat the drill water samples. 30 μl of each blend was used to treat 10 ml of drill water. 30 μl of the calcium chloride solution or the zirconium acetate solution was dosed separately into individual samples as controls. The formulations were allowed to react with the components in the drill water, and allowed a period of time for floccules to settle.

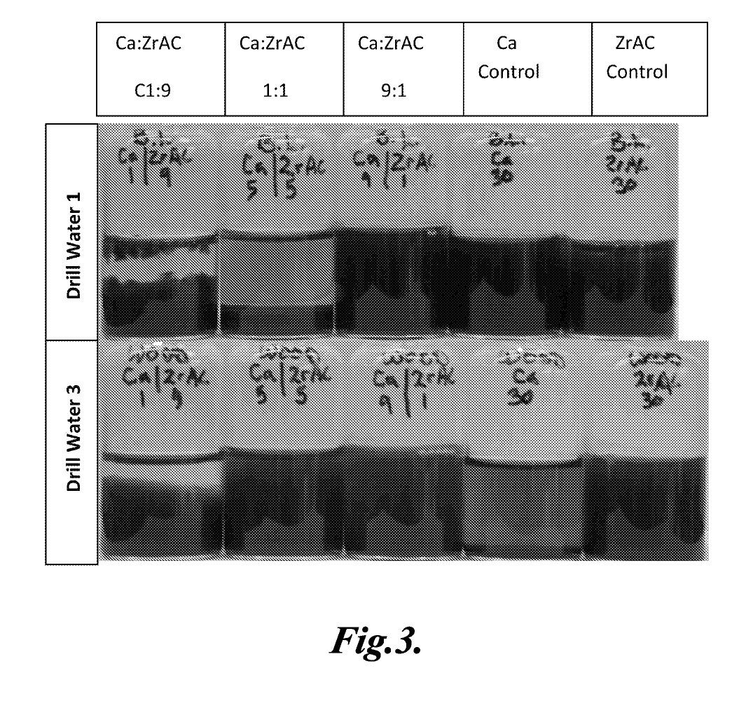

The results are seen in FIG. 3.

As seen in FIG. 3, for drill water 1 samples, neither the calcium chloride treated control nor the zirconium acetate treated control exhibited significant flocculation or clarification. This is in contrast however to the drill water 1 samples treated with the 1:9 and the 1:1 blends of calcium chloride and zirconium acetate formulations. The 9:1 blend did not appear to be any better compared to the calcium chloride or zirconium acetate alone.

In the drill water 3 samples, zirconium acetate alone did not appear to affect significant flocculation and clarification, while calcium chloride did. The 1:9 calcium:zirconium blend was also more effective compared to the 1:1 and the 9:1 formulations.

Example 2 demonstrates that calcium chloride can be effective in flocculation and settling of suspended solids in drill water and also demonstrates that synergy can be achieved with combinations of zirconium acetate and calcium chloride.

### Example 3

### Treatment of Drill Water with Calcium Chloride, Zinc Chloride, Alone and in Combination

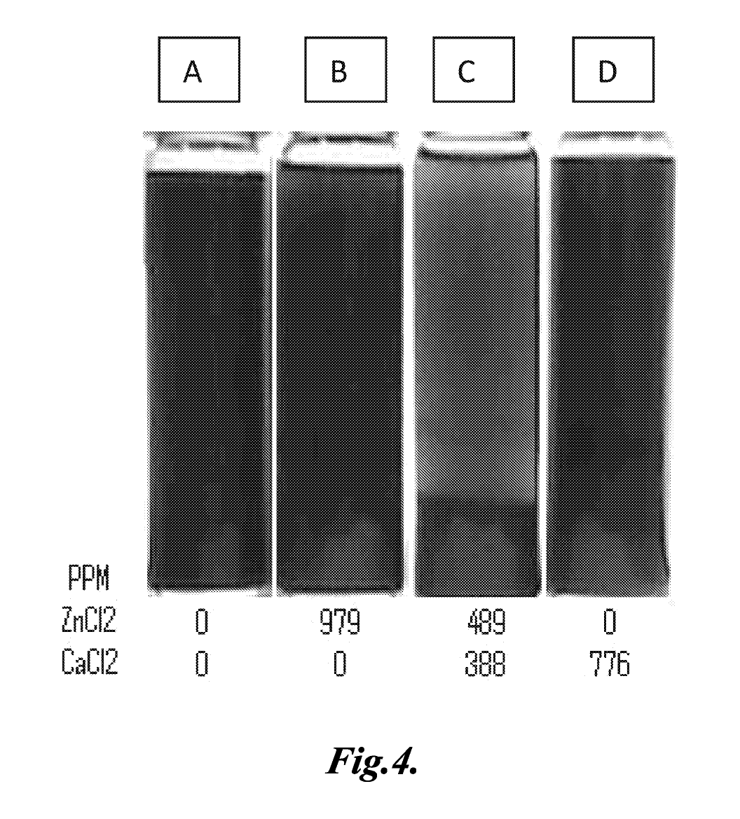

Drill water obtained from the Haynesville shale in Louisiana was treated with the liquid solution of calcium chloride alone at 776 ppm (as calcium chloride) or a liquid solution of zinc chloride alone at 979 ppm (as zinc chloride). The formulations were allowed to react with the components in the drill water and allowed a period of time for floccules to settle. The results are shown in FIG. 4.

As seen in FIG. 4, samples D and B, neither solution alone was significant in flocculation and clarification. However, when drill water was treated with a combination of solutions of zinc chloride and calcium chloride at 489 ppm (as zinc chloride) and 388 ppm (as calcium chloride), respectively, significant flocculation and settling and clarification was observed, as seen in sample C. This example demonstrates that calcium chloride and zinc chloride can act synergistically in flocculation and settling of hydrocarbons, clay fines, and clarification of shale gas drill water.

### Example 4

### Treatment of Drill Water with Calcium Chloride and Zinc Chloride, Alone and in Combination at Increased Doses

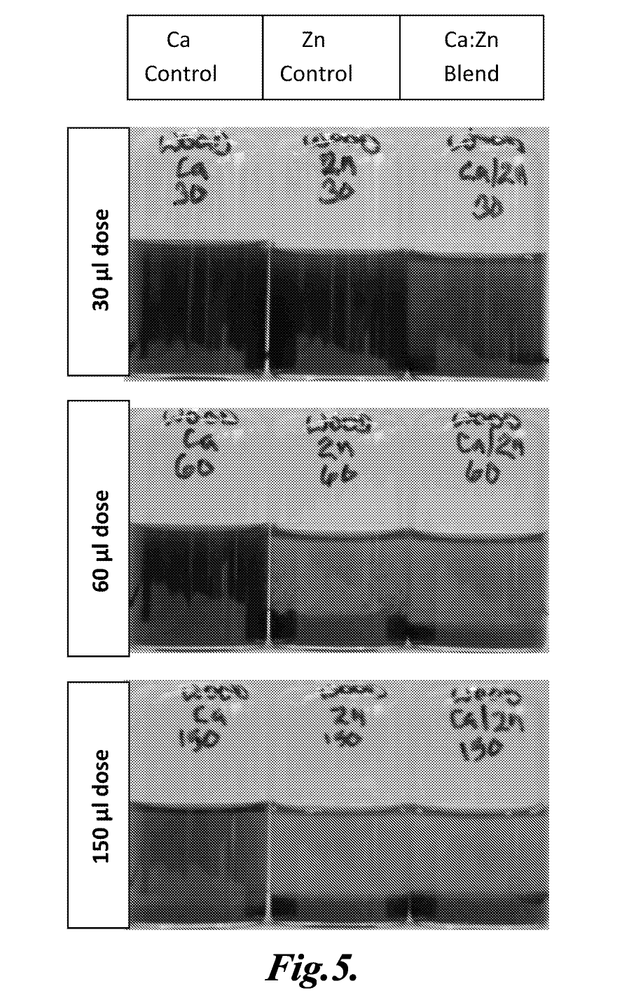

1.96 g of zinc chloride anhydrous and 1.55 g of calcium chloride anhydrous were mixed with 10 ml of DI water in a glass scintillation vial to create a blend. Additionally, controls for the zinc chloride anhydrous and the calcium chloride anhydrous were made at the same concentrations as that in the blend. The formulations were added to drill water samples at 15 μl, 30 μl, 60 μl, and 150 μl per 10 ml drill water. The formulations were allowed to react with the components in the drill water and allowed a period of time for floccules to settle. The results are shown in FIG. 5.

As seen in FIG. 5, increasing the dose of all three formulations results in improved flocculation and settling/clarification. At the lowest dose (30 μl/10 ml drill water), both calcium chloride and zinc chloride are not as effective as when combined together demonstrating a synergistic effect. At the higher doses, zinc chloride is more effective compared to calcium chloride alone and about the same as compared to the combination.

### Example 5

### The Effect of Zirconium Acetate on Flocculation and Settling and Clarification of Post Calcium Chloride Treatment

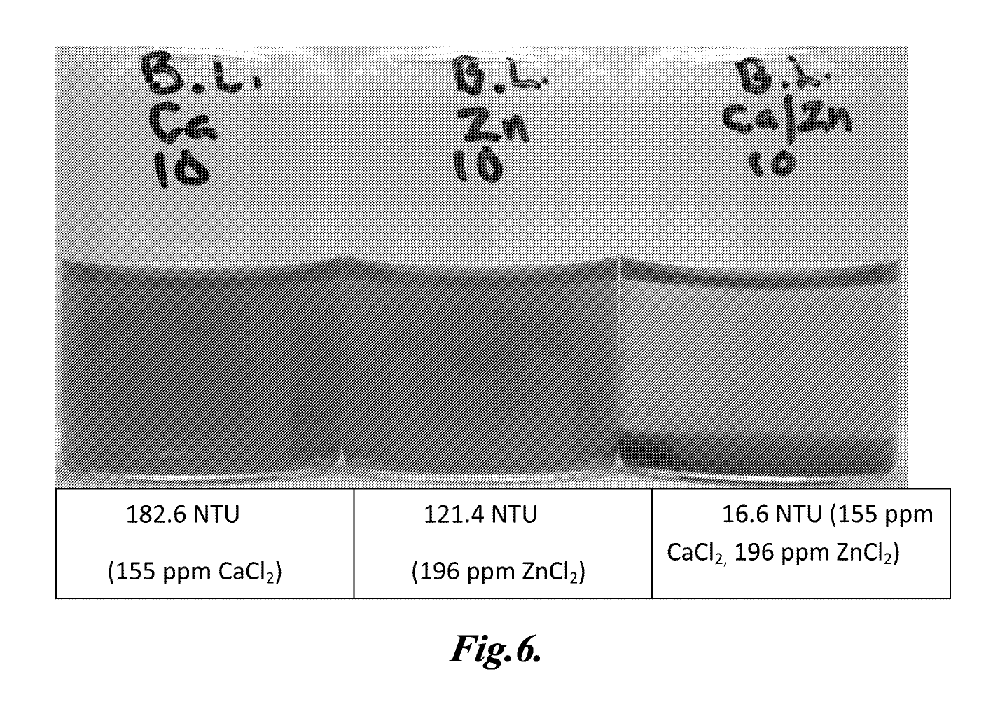

A drill water sample containing suspended hydrocarbons was centrifuged at approximately 13,000×g to isolate the hydrocarbons and other fine contaminants. The supernatant was decanted off and discarded, and the pelleted material was isolated and resuspended in deionized water. A blended formulation of zinc chloride and calcium chloride was prepared by dissolving 1.96 g of anhydrous zinc chloride and 1.55 g of anhydrous calcium chloride in 10 ml of deionized water in a scintillation vial. A formulation zinc chloride (1.96 g) was prepared by dissolving anhydrous zinc chloride in 10 ml of deionized water in a separate glass vial. A formulation of calcium chloride (1.55 g) was prepared by dissolving anhydrous calcium chloride in 10 ml of deionized water in a separate glass vial. The formulations were dosed into the drill water at 155 ppm CaCl₂ and 196 ppm ZnCl₂. Turbidity was measured before and after treatment. The formulations were allowed to react with the components in the drill water, and allowed a period of time for floccules to settle. The results are shown in FIG. 6.

As seen in FIG. 6, both calcium chloride and zinc chloride were not as effective in inducing flocculation and resultant settling and clarification of isolated hydrocarbons and other suspended matter present in shale-gas drill water, at 155 ppm and 196 ppm, respectively, compared to both at the same concentration. At the higher dose of 465 ppm and 588 ppm calcium chloride and zinc chloride, respectively, zinc chloride was as effective as the blend.

### Example 6

### Sequential Method for Removing Suspended Hydrocarbons and Other Suspended Matter from Drill Water

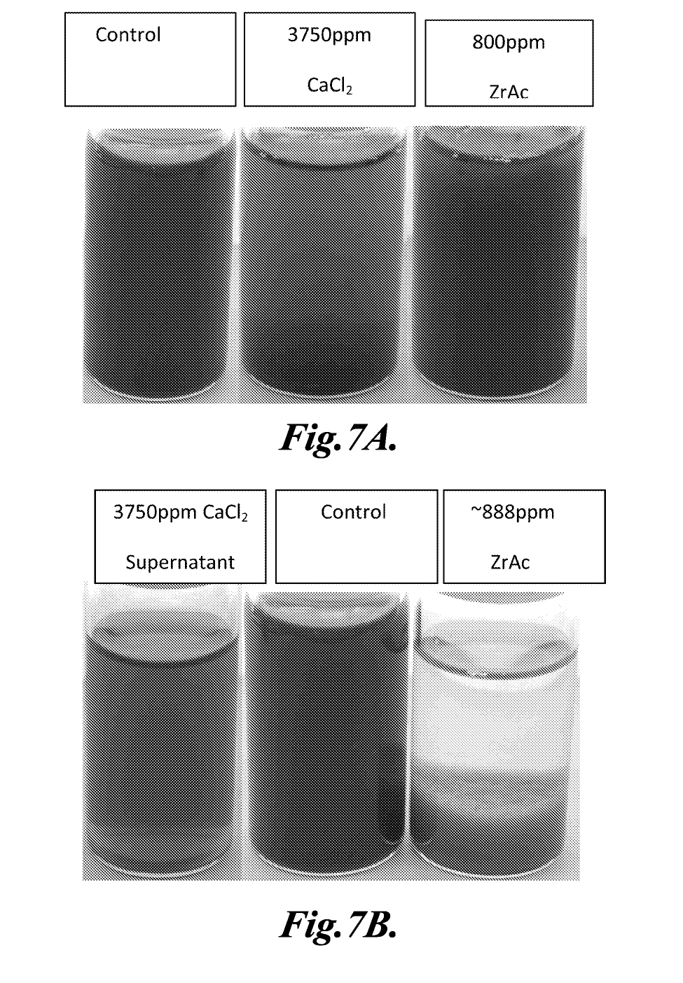

150 μl of a calcium chloride solution made at 25 g/50 g DI and 100 μl of a 15% to 16% zirconium acetate solution (as zirconium) were each dosed into individual 20 ml of drill water. The formulations were allowed to react with the components in the drill water, and allowed a period of time for floccules to settle. The results are shown in FIG. 7A. After 30 minutes, approximately 18 ml of the supernatant of the calcium chloride treated drill water was transferred to a new vial and then 100 μl of the 15% to 16% zirconium acetate solution (as zirconium) was dosed in. The zirconium acetate solution was allowed to react with the components in the supernatant, and allowed a period of time for floccules to settle. The results are shown in FIG. 7B.

As seen in FIG. 7A, calcium chloride was effective in inducing flocculation and settling and clarification of hydrocarbons and other suspended matter in the drill water when compared to the control.

The supernatant from the 3,750 ppm calcium chloride treated drill water in FIG. 7A was isolated (see 3,750 ppm CaCl₂ Supernatant in FIG. 7B) and then treated with zirconium acetate at a final concentration of about 888 ppm. The result is seen in the 888 ppm ZrAc sample in FIG. 7B. Treatment of the calcium chloride supernatant with ZrAc dramatically reduced the fine suspended hydrocarbons, and other suspended matter not reduced by calcium chloride, and improved the water clarity significantly. This example demonstrates that treating drill water with calcium chloride, followed by settling and collecting the supernatant liquid, and then treating the supernatant liquid with zirconium acetate is highly effective in removal of suspended matter and significantly improves water clarity. It is envisioned that the sequential treatment method with zirconium acetate following zinc chloride treatment would be as effective. Furthermore, instead of collecting the supernatant liquid, the method may employ a filter to capture the floccules and collect and treat the filtrate with the zirconium acetate.

### Example 7

### Identification of Settled Solids in Shale Gas Drill Water

One liter of a shale gas drill water sample obtained from the Haynesville Shale formation was treated with 10 ml of a formulation of 4 g of calcium chloride dihydrate, 1 g of magnesium chloride hexahydrate, and 10 ml of 0.05% glucomannan, and allowed to settle for 1 hour. Treatment of the dark brown drill water with the formulation resulted in the formation of a dark colored sediment of settled solids and an amber supernatant. The table identifies the suspended matter present in the drill water sample that was flocculated and settled by the formulation.

Settled solids isolated by centrifugation were analyzed for semi-volatile organic compounds (SVOC), hydrocarbons and silicon. The results are shown in TABLE 1 below.

TABLE 1

| | | | |
|---|---|---|---|
| | | Reporting | |
| Analyte | Result | Limit | Units |

SVOC by GC/MS SIM 8270C SIM

| | | | |
|---|---|---|---|
| Naphthalene | 570 | 62 | μg/Kg dry weight |
| 2-Methylnaphthalene | 3800 | 62 | μg/Kg dry weight |
| 1-Methylnaphthalene | 5800 | 62 | μg/Kg dry weight |
| Acenaphthylene | 270 | 62 | μg/Kg dry weight |
| Acenaphthene | ND | 62 | μg/Kg dry weight |
| Fluorene | 500 | 62 | μg/Kg dry weight |
| Phenanthrene | 2000 | 62 | μg/Kg dry weight |
| Anthracene | 530 | 62 | μg/Kg dry weight |
| Fluoranthene | 1200 | 62 | μg/Kg dry weight |
| Pyrene | 1700 | 62 | μg/Kg dry weight |
| Benzo[a]anthracene | ND | 62 | μg/Kg dry weight |
| Chrysene | ND | 62 | μg/Kg dry weight |
| Benzo[b]fluoranthene | 76 | 62 | μg/Kg dry weight |
| Benzo[k]fluoranthene | ND | 62 | μg/Kg dry weight |
| Benzo[a]pyrene | ND | 62 | μg/Kg dry weight |
| Indeno[1,2,3-cd]pyrene | ND | 62 | μg/Kg dry weight |
| Dibenz(a,h)anthracene | ND | 62 | μg/Kg dry weight |
| Benzo[g,h,i]perylene | 78 | 62 | μg/Kg dry weight |

Northwest Hydrocarbon Identification by GC NWTPH-HCID

| | | | |
|---|---|---|---|
| Motor Oil | 3600 | 1200 | mg/Kg dry weight |
| Gasoline | 8100 | 240 | mg/Kg dry weight |
| #2 Diesel (>C12-C24) | 47000 | 610 | mg/Kg dry weight |

Metals Analysis by ICP 6010B

| | | | |
|---|---|---|---|
| Silicon | 6600 | 590 | mg/Kg dry weight |

Example 7 demonstrates that the flocculation and settling of these constituents in drill water from shale gas operations can be accomplished with the formulation described.

### Example 8

### Dose Response Analysis for Drill Water Treated with Combinations of Zinc Chloride and Calcium Chloride, and Ferric Chloride and Chitosan

This example is used to determine the flocculation performance using various combinations of zinc chloride/calcium chloride (Formulation 1) and ferric chloride/chitosan (Formulation 2) at different concentrations on drill water. The sample used in this test was drill water from the Haynesville shale, Shreveport, La. The sample was dark colored and smelled slightly like sulfur. The turbidity of the mixed test sample was >>1100 NTU. The pH of the sample was ˜6.91.

Test Method 1:

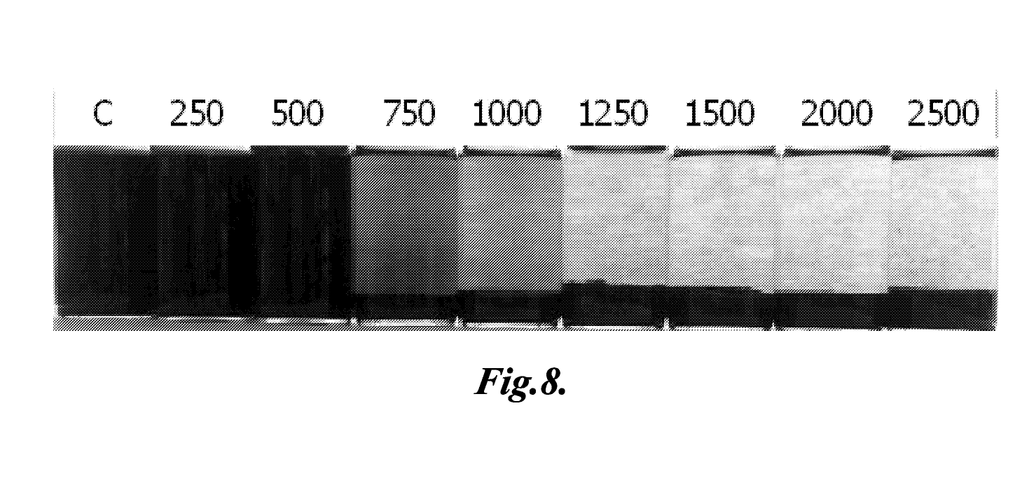

Add 20 ml of drill water sample to each of the test vials. Then the appropriate amount of Formulation 1 was added to each vial and mixed, except to the control sample (C). The vials were left undisturbed for 48 hours without aeration to determine maximum flocculent performance. The results are seen in FIG. 8 after 48 hours, wherein ppm (volume) concentration is listed on top of the vials. C=control has 0 ppm of Formulation 1.

Floccules are noticed starting in the vial with 750 ppm of Formulation 1 and floccing improves with increasing concentration of Formulation 1. No pH adjustment was used during this test method.

The minimal dose of Formulation 1 required to break the sample is 750 ppm (volume). The pH of this sample after treatment was 6.18.

Test Method 2:

Formulation 1 and Formulation 2 are used in combination. Add 20 ml of sample to each of the test vials. Formulation 1 was then added to the vials in the concentrations shown in the Table 2. Doses of Formulation 1 ranged from 0-1250 ppm (volume). Then the appropriate amount of Formulation 2 from Table 2 was added to each vial and mixed. Doses of Formulation 2 ranged from 0-1250 ppm (volume). The vials were allowed to settle for 48 hours without aeration. No pH adjustment was used during this trial.

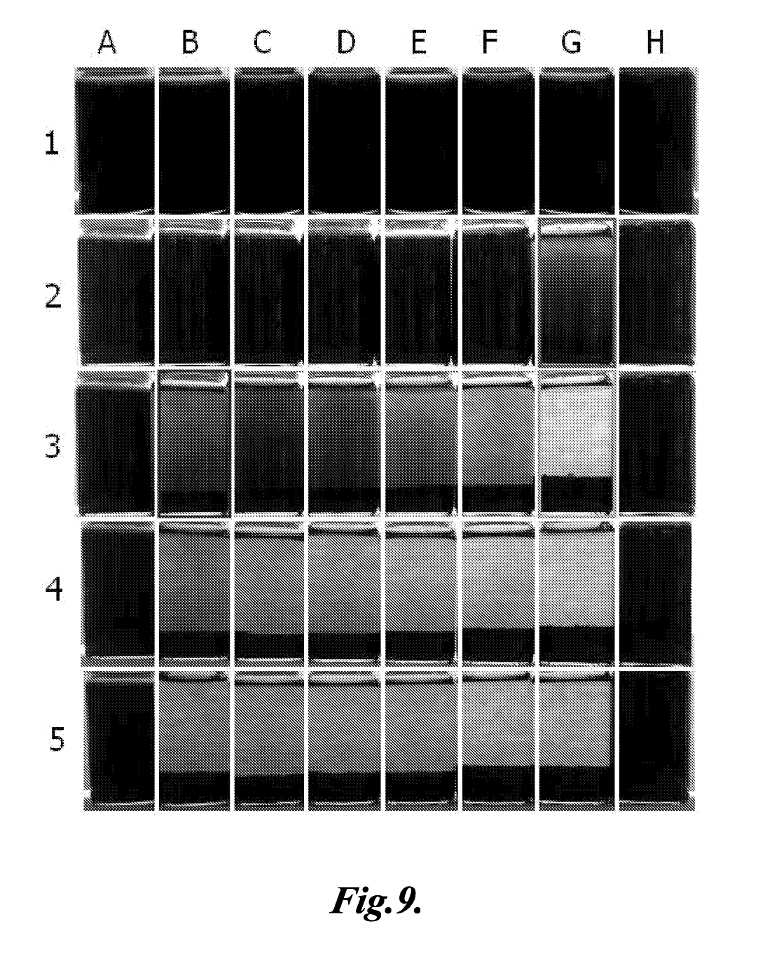

The floccing results are seen in FIG. 9.

TABLE 2

| | Formulation 1 (ppm) | Formulation 2 (ppm) |
|---|---|---|
| A1 | 0 | 0 |
| A2 | 0 | 0 |
| A3 | 0 | 0 |
| A4 | 0 | 0 |
| A5 | 0 | 0 |
| B1 | 250 | 0 |
| B2 | 500 | 0 |
| B3 | 750 | 0 |
| B4 | 1000 | 0 |
| B5 | 1250 | 0 |
| C1 | 250 | 250 |
| C2 | 500 | 250 |
| C3 | 750 | 250 |
| C4 | 1000 | 250 |
| C5 | 1250 | 250 |
| D1 | 250 | 500 |
| D2 | 500 | 500 |
| D3 | 750 | 500 |
| D4 | 1000 | 500 |
| D5 | 1250 | 500 |
| E1 | 250 | 750 |
| E2 | 500 | 750 |
| E3 | 750 | 750 |
| E4 | 1000 | 750 |
| E5 | 1250 | 750 |
| F1 | 250 | 1000 |
| F2 | 500 | 1000 |
| F3 | 750 | 1000 |
| F4 | 1000 | 1000 |
| F5 | 1250 | 1000 |
| G1 | 250 | 1250 |
| G2 | 500 | 1250 |
| G3 | 750 | 1250 |
| G4 | 1000 | 1250 |
| G5 | 1250 | 1250 |
| H1 | 0 | 1250 |
| H2 | 0 | 1250 |
| H3 | 0 | 1250 |
| H4 | 0 | 1250 |
| H5 | 0 | 1250 |

The minimal dose of Formulation 1 required to break the sample was 750 ppm (volume), and is shown in cell B3. The final pH of this treated sample was 6.18.

The minimum dose of Formulation 1 can be reduced from 750 ppm to 500 ppm by adding 1250 ppm of Formulation 2. The final pH of this treated sample was 5.39. This sample is shown in cell G2.

Compared to G2, a clearer supernatant is observed when the dose of Formulation 1 is increased to 750 ppm and used in combination with 1250 ppm of Formulation 2. The final pH of this treated sample was 5.30. This sample is shown in cell G3.

This data confirms that the combination of zinc chloride with calcium chloride (Formulation 1) and ferric chloride with chitosan (Formulation 2) is more effective than either alone in settling suspended organic hydrocarbons. Compare, for example B3 with H3.

The supernatant was observed to become clearer as more Formulation 1 was added to those samples treated with Formulation 2, see columns E and F. The concentration of Formulation 1 increases moving to the bottom on the dose grid.

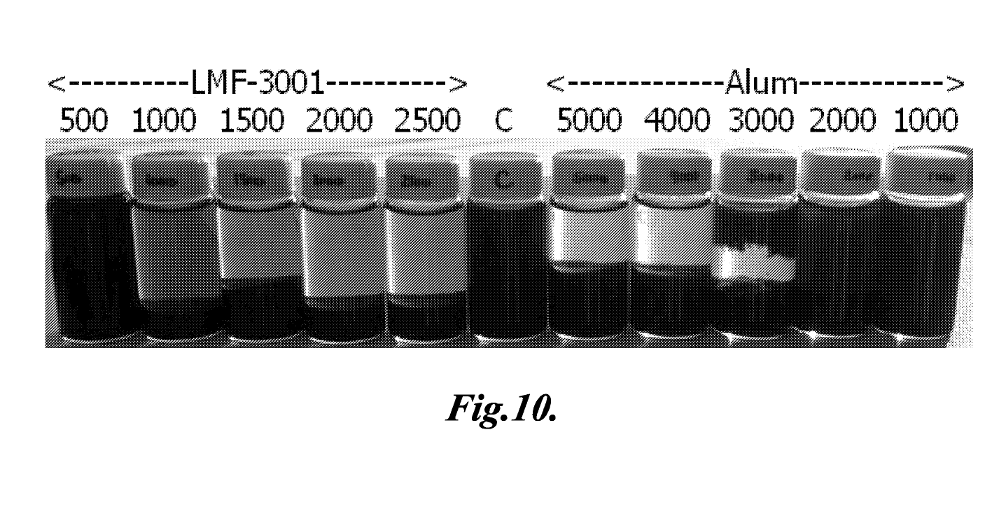

Taking evidence from previous trials, Formulation 1 consistently performs at half of the dose of Alum required to break drill water samples (1:2 volume of Formulation 1 to Alum). See FIG. 10 showing concentrations of Formulation 1 ranging from 500-2500 ppm (volume), and Alum ranging from 1000-5000 ppm (volume) in drill water samples, the same as used in Test Methods 1 & 2.

While illustrative embodiments have been illustrated and described, it will be appreciated that various changes can be made therein without departing from the spirit and scope of the invention.

1-27. (canceled)

28. A method for removing components from drill water, comprising: dispensing a flocculating formulation to the water; allowing the formation of floccules in the water, wherein the floccules contain a component to be removed; and separating the floccules with the component from the water, wherein active components of the flocculating formulation consist of zinc chloride and calcium chloride.

29. The method of claim 28, wherein the zinc chloride and calcium chloride are in solution.

30. The method of claim 28, wherein the formulation is a liquid, solid, or slurry.

31. The method of claim 28, wherein the formulation includes water.

32. The method of claim 28, further comprising a second step of dispensing zirconium oxychloride or zirconium acetate or both into the water, and allowing floccules to form from the second step; and separating the floccules from the water.

33. The method of claim 28, wherein the drill water is produced water, frac water, or flow back water.

34. The method of claim 28, further comprising a second step of dispensing one or more polysaccharides selected from the group consisting of guar gum, xanthan gum, alginate, carboxymethylcellulose, chitosan, a cationic guar, a starch, a cationic starch, an anionic starch, carrageenans, pectin, arabic gum, karaya gum, tragacanth gum and glucomannan.

35. The method of claim 28, further comprising a second step of dispensing magnesium chloride.

36. The method of claim 28, further comprising a second step of dispensing ferric chloride and chitosan.

37. The method of claim 28, further comprising a second step of dispensing magnesium chloride and glucomannan.

38. The method of claim 28, further comprising a second step of dispensing zirconium acetate and chitosan.

39. The method of claim 28, further comprising a second step of dispensing zirconium acetate and a polysaccharide.

40. A method for removing components from drill water, comprising: dispensing a flocculating formulation to the water; allowing the formation of floccules in the water, wherein the floccules contain a component to be removed; and separating the floccules with the component from the water, wherein active components of the flocculating formulation consist of calcium chloride and zirconium acetate.

41. The method of claim 40, wherein the calcium chloride and zirconium acetate are in solution.

42. The method of claim 40, wherein the formulation is a liquid, solid, or slurry.

43. The method of claim 40, wherein the formulation includes water.

44. The method of claim 40, further comprising a second step of dispensing zirconium oxychloride or zirconium acetate or both into the water, and allowing floccules to form from the second step; and separating the floccules from the water.

45. The method of claim 40, wherein the drill water is produced water, frac water, or flow back water.

46. The method of claim 40, further comprising a second step of dispensing a one or more of a polysaccharide selected from the group consisting of guar gum, xanthan gum, alginate, carboxymethylcellulose, chitosan, a cationic guar, a starch, a cationic starch, an anionic starch, carrageenans, pectin, arabic gum, karaya gum, tragacanth gum, and glucomannan.

47. The method of claim 40, further comprising a second step of dispensing magnesium chloride.

48. The method of claim 40, further comprising a second step of dispensing ferric chloride and chitosan.

49. The method of claim 40, further comprising a second step of dispensing magnesium chloride and glucomannan.
